(19) United States
(12) Patent Application Publication
(10) Pub. No.: US 2008/0079538 A1
(43) Pub. Date: Apr. 3, 2008

(54) PROMOTIONAL SIGN MANAGEMENT SYSTEM AND WORKFLOW FOR RETAIL APPLICATIONS

(75) Inventor: Jesse Davis, Berkeley, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: W5 Networks, Inc.

(21) Appl. No.: 11/535,060

(22) Filed: Sep. 25, 2006

(51) Int. Cl. G05B 19/00

(52) U.S. Cl. 340/5.91; 40/541; 340/686.1; 340/691.1; 705/14; 345/2.3; 235/383

(57) ABSTRACT

Systems, apparatus, and methods for utilizing external attached signs in conjunction with display enabled wireless devices are provided. Wireless devices transmit signals to and receive signals from disconnected systems preferably comprising one or more access points or hand-held devices. The access points and hand-held devices preferably communicate with a server which operates to manage the wireless devices. Optionally, the wireless devices take various actions depending on the presence or absence of an attached sign. These actions may include initiating a communication, changing a displayed message, or flashing a LED. Optionally, the server receives messages from the wireless devices containing information relating to the presence or absence of an attached sign and transmits a message back to the wireless devices in response.

### FIELD OF THE INVENTION

The present invention relates to promotional sign management systems and workflows, and more specifically to such systems and workflows coupled with Electronic Shelf Labels (ESLs).

### BACKGROUND INFORMATION

U.S. Pat. No. 5,448,226 describes a shelf talker management system and a method for auditing the electronic shelf labels to which the shelf talkers are attached in order to ensure the proper signage is placed.

US Patent Application No. 20060010743 describes an adhesive shelf talker with an upper and lower portion. The upper portion is described to contain non-promotional product information, while the separable lower portion is described to contain promotional information.

U.S. Pat. No. 6,981,343 describes an extended liner shelf talker with a top portion that adheres to a shelf and a middle portion which serves as a docking location for a lower portion which may be optionally attached.

U.S. Pat. No. 6,000,611 describes an Electronic Price Label (EPL) with a two part shelf attach mechanism. The second portion of the shelf attach mechanism is described to be able to hold the EPL itself as well as an optional retainer for securing a sign.

U.S. Pat. No. 5,943,654 describes a method of assigning and displaying a promotional message on an Electronic Price Label (EPL) by means of (presumably) a server causing an EPL to display a stored promotional message from a promotional message file.

U.S. Pat. No. 5,771,005 describes an auxiliary electronic display that may be attached to an Electronic Price Label (EPL). The EPL automatically senses when and if such an auxiliary display is attached or removed. A terminal may query the EPL as to the presence of such an auxiliary display and optionally send a message to the EPL for display on the auxiliary display.

U.S. Pat. No. 7,040,536 describes an ESL device itself utilizing a Liquid Crystal Display (LCD) to display messages and prices.

U.S. Pat. No. 6,749,116 describes a price display system comprising an electronic display strip comprising non-volatile memory, an electronic display area, and a signaling system, a server, and a hand-held device. The sensor described as a part of the electronic display strip is meant for the sole purpose of receiving signals from a hand-held device which cause prices to move along to specified positions along the display.

U.S. Pat. No. 6,550,673 describes an electronic display system for displaying sales item data on store shelves. The electronic display system comprises electronic display devices and a display bus system attached to the shelves for wired communication to the display devices.

### SUMMARY

An object of the present invention is to provide a wireless device capable of displaying a message or price onto which can be attached a non-electronic external sign.

A further object of the present invention is to provide a method for such a wireless device to recognize the presence or absence of an attached sign and to take action when the attach status changes. Actions that the device might take include, for example, alerting a disconnected system that a sign has been attached, changing the displayed message to a different already stored message, and/or turning on or flashing an attached Light Emitting Diode (LED).

A further object of the present invention is to provide methods for managing and deploying promotional messages using such devices.

Further objects, aspects, and advantages of the present teachings will be readily understood after reading the following description with reference to the drawings and the appended claims.

### BRIEF DESCRIPTION OF THE DRAWINGS

FIG. 1 shows a representative block diagram of a wireless device with a wireless transceiver, controller, display, sign, sign interface, Light Emitting Diode (LED), and optional sensor according to an embodiment of the invention.

FIG. 2 shows a representative physical realization of a wireless device with a display which shows a message and an additional sign that attaches to the wireless device which shows an additional message according to an embodiment of the invention.

FIG. 3 shows a representative system comprising access points, a server, and/or a hand-held device for wirelessly communicating with a multiplicity of wireless devices according to an embodiment of the invention.

### GLOSSARY OF TERMS

The following abbreviations are utilized in the following description, which are intended to have the meanings provided as follows:

ADC—analog to digital converter

AP—access point

CAN—controller area network

ESL—electronic shelf label

IC—integrated circuit

IIC/I2C/I²C—inter-integrated circuit

IR—infra-red

LCD—liquid crystal display

LED—light emitting diode

OLED—organic light emitting diode

POS—point of sale

RAM—random access memory

RF—radio frequency

Rx—receiver

SPI—serial peripheral interface

Tx—transmitter

### DETAILED DESCRIPTION

Each of the additional features and teachings disclosed below may be utilized separately or in conjunction with other features and teachings to provide improved wireless sensing systems and methods for designing and using the same. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

FIG. 1 shows a block diagram of a wireless device 300 according to an embodiment of the invention. The wireless device comprises a wireless transceiver 110, a wireless transceiver physical interface 111, a controller 120, a display 130, a sign 140, a sign interface 14, a Light-Emitting Diode (LED) 150, and an optional sensor 160. The wireless transceiver 110 may be implemented by any type of wireless communication device and method either as an integrated or discrete component. Some common wireless communication methods include, but are not limited to, Radio Frequency (RF), Infra-Red (IR), inductive coupling, and ultra-sound. The wireless transceiver physical interface 111 depends on the specific type of wireless transceiver 110 used. Some examples include an antenna for RF, an LED for IR, an antenna coil for inductive coupling, or a speaker for ultra-sound.

The controller 120 in FIG. 1 comprises the circuits and/or code which make up the logical operation and management of the full device. The controller 120 may be static or reconfigurable (e.g. reprogrammable), and incorporates the sensor interface. The controller 120 itself may be either an integrated or discrete component within the wireless device 300, and serves to operate the display 130, wireless transceiver 110, and the optional sensor 160. The interface on the controller 120 to the optional sensor 160 depends on the type of sensor attached, but may be via, for example, an Analog-to-Digital Converter (ADC), a Serial Peripheral Interface (SPI) digital bus, an Inter-Integrated Circuit (IIC/I2C/I²C) digital bus, an RS-232 digital bus, or a Controller Area Network (CAN) digital bus.

In one implementation, the controller 120 can detect the presence or absence of the sign 140, 230 by means of the sign interface 145. In one implementation, the sign interface 145 detects the presence or absence of the sign 140, 240 by means of a change in inductance caused by inserting a tab 245 on the top portion of the sign 140, 240 into a slot 230 on the bottom portion of the device 200, 300. To cause the change in inductance, tab 245 may be covered with a conductive material, such as, for example, metal or carbon ink. The device 200, 300 may detect either a change in mutual inductance between two coils, or a change in self inductance of a single coil to determine the presence or absence of the sign 140, 240. The device 200, 300 may also detect the presence or absence of the sign 140, 240 by means of a change in light transmission caused by inserting the tab 245 between a light emitter and detector in the device, and/or by means of a change in conductance caused by inserting the tab 245, e.g., between conductive plates in the device. In one implementation, the controller can perform an action when a sign 140, 240 is attached or detached. This action may be, for example, to initiate a communication to an Access Point AP 320 or hand-held device 325, to change the message 215 displayed by the display 130, 210, and/or to cause the LED 150, 220 to flash in a specific pattern.

The display 130, 210 can display messages such as prices and/or promotions. The display 130 is an integral part of these devices since the primary purpose they serve is to display information to customers. This display 130, 210 can be based, for example, on Liquid Crystal Displays (LCDs), Organic Light Emitting Diodes (OLEDs), bi-stable display technology, or electronic ink. The display 130 can be segmented or dot-matrix, black and white or color.

The LED 150, 220 portion of the wireless device 200, 300 may be operated by the controller 120 for various reasons. The LED 150, 220 may be operated to stay on continuously, flash once, or flash in an arbitrary repeated pattern. Furthermore, the operation of the LED 150, 220 may be pre-defined and programmatic, may be in response to a message received by the device 200, 300, may be in response to the attachment or detachment of a sign 140, 240, or may be in response to data collected from an optional sensor 160. In one implementation, for example, the LED 150, 220 can be used to alert store personnel of a problem with the device. In another implementation, for example, it can be used to draw attention to the device from customers of the store.

A sensor 160 may also be an optional component of the wireless device 200, 300. If attached, this sensor 160 will allow the wireless device 200, 300 to collect environmental data from its surroundings. When used in a network 360, the devices 200, 300 can provide distributed data feedback to environmental control systems and/or store employees. This sensor 160 allows environmental monitoring, logging, and alerting, and allows a host of potential applications including, for example, distributed temperature monitoring, distributed presence detection, and/or distributed noise level monitoring. In one implementation, for example, the device 200, 300 can be configured to initiate a communication session with an AP 320 or hand-held device 325 if the sensor data meets a certain set of criteria. Further details on the optional sensor can be found in co-pending application Ser. No. ______, titled “Sensor Monitoring, Logging, and Alerting via Display Enabled Wireless Devices for Retail Applications,” filed on the same date as the present application, the entire specification of which is incorporated herein by reference.

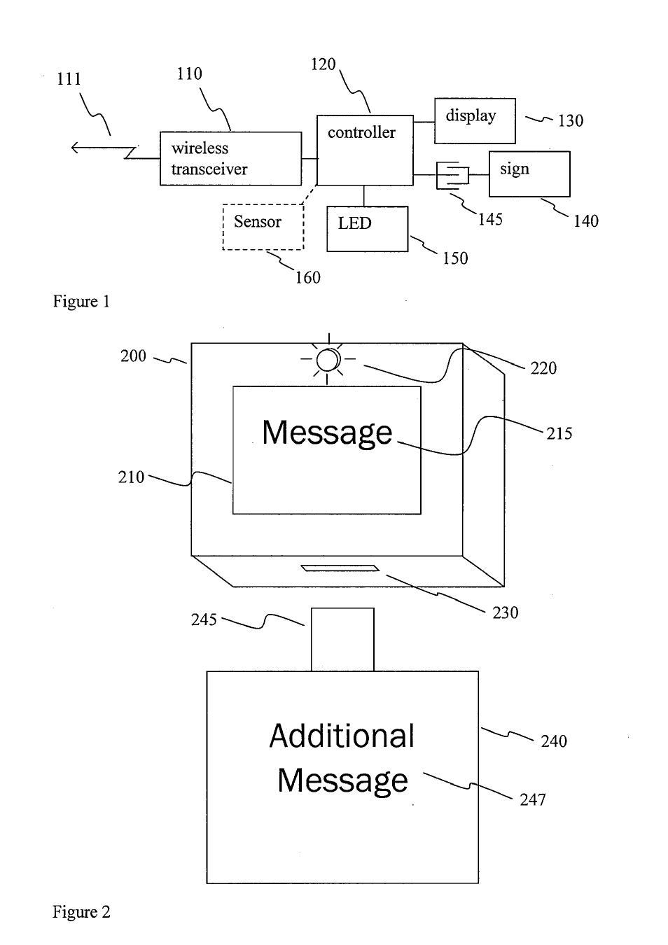

FIG. 2 shows a wireless device 200, 300 physical representation with display message 215 being displayed by the display 130, 210, LED 150, 220, sign attach point 230, and a sign 140, 240 with a sign attachment mechanism 245 displaying an additional message 247. The description of FIG. 1 has already provided descriptions of the display 130, 210, LED 150, 220, and sign 140, 240, so the FIG. 2 description will only add descriptions of these components that have not already been taught.

The display 130, 210 is on the front of the device 200, 300 with the back of the device having a mounting mechanism to attach the device to objects, such as, for example, shelves, poles, hooks, display cases, flat surfaces, and/or doors. The display 130, 210 displays a message 215 including, for example, price, product, and/or promotion information for a product in a retail store. The display 130, 210 is operable by the controller 120 portion of the device 200, 300.

The LED 150, 220 has been described by the description of FIG. 1.

The sign attachment point 230 is the location on the device 200, 300 to which the sign 140, 240 is attached. It may comprise of any type of attachment mechanism including, for example, a mechanical clip, a spring loaded clip, a friction fitting, or a molded fitting. An example implementation is shown in FIG. 2. In this implementation, the sign attachment point 230 is a slot on the device 200, 300, into which a tab 245 on the sign 140, 240 is inserted. The sign 140, 240 may be held in place by a molded friction fitting.

The sign 140, 240 is a non-electronic display that shows an additional message 247 to supplement or complement the message 215 displayed by the display 130, 210. A common use for such a sign 140, 240, for example, is to display temporary promotional information relating to a product. The sign 140, 240 may comprise, for example, paper, cardboard, plastic, etc.

The sign attachment mechanism 245 is a portion of the sign 140, 240 which is used to attach the sign to the device 200, 300. This sign attachment mechanism 245 may comprise any type of attachment mechanism including, for example, a mechanical clip, a spring loaded clip, a material different than the sign 140, 240 molded onto the side of the sign 140, 240, and/or a portion of the sign material itself. An example implementation is shown in FIG. 2. In this implementation, the sign attachment mechanism 245 is a portion of the sign material itself that sticks out of the center of the top of the sign 140, 240 and has a narrower width than the rest of the sign 140, 240. When the sign attachment mechanism 245 is inserted into the sign attachment point 230 on the device 200, 300, it is held in place by a molded friction fitting. In this implementation, the sign attachment mechanism may be covered with a conductive material to allow the sign interface 145 to detect its presence or absence by, e.g., by a change in inductance caused the conductive material.

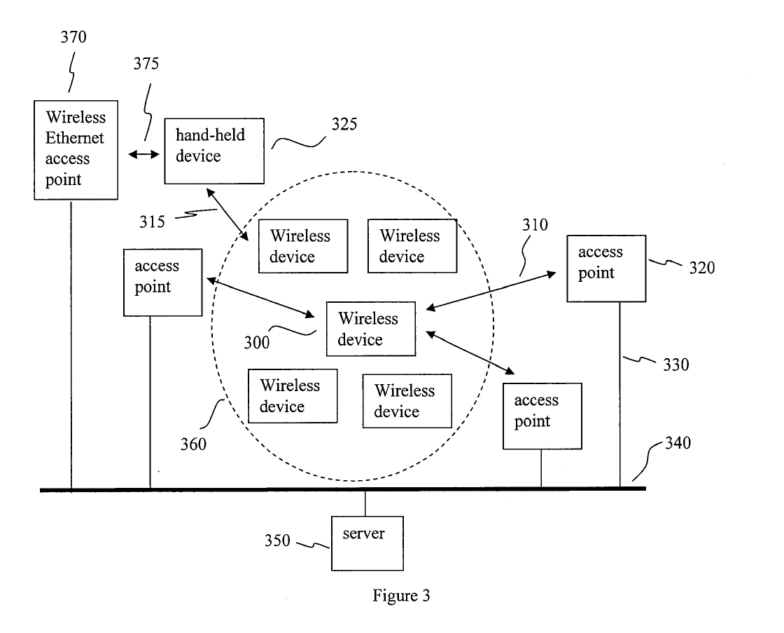

FIG. 3 shows many of these wireless devices 200, 300 used simultaneously in different physical locations, e.g., within a store, to form a distributed network of wireless devices 360. These wireless devices can communicate directly with physically disconnected devices, such as, for example, an AP 320 over a wireless link 310, or a hand-held device 325 over a wireless link 315. The APs 320 are connected, e.g., via Ethernet 330, to a network 340 with a server 350 to manage them. The hand-held device may optionally also connect to the server 350 network 340 via a wireless Ethernet access point 370 over a wireless link 375.

The wireless devices 200, 300 may communicate data to a disconnected system with or without request. The data that is communicated to a disconnected system may include, for example, sign 140, 240 attachment information, current message 215 displayed, sensor 160 data, and/or status information. In one implementation, a server 350 may be used to log and store the communicated data, and/or to send a message back to the wireless device 200, 300 from which the data came, to another wireless device 200, 300, or to a group of wireless devices 200, 300.

Examples of applications are herein given to demonstrate potential utilities of the described invention. These examples are not intended to limit the scope of the invention, but only to show potential uses for the invention

In one implementation, for example, the server 350 may send a message to a wireless device 200, 300 with a new message to display when a sign 140, 240 is attached. In this implementation, the controller 120 may store the new message in memory and not display the new message until the sign 140, 240 is attached. Optionally, the wireless device 200, 300 may initiate a flashing of its LED 150, 220 in order for a store employee to more quickly find the device 200, 300 to which a particular sign 140, 240 should be attached. When the sign 140, 240 is attached to the device 200, 300, the controller 120 detects the presence of the sign 140, 240 by means of the sign attachment interface and mechanism 145 and can change the message 215 on the display 130, 210 to the new message previously received from the server 350. The controller may also optionally change the flashing pattern of the LED 150, 220, turn it off completely, or turn it on continuously.

When the sign 140, 240 is attached to the device 200, 300, the controller 120 may also send a confirmatory message back to the server 350, for example. When this confirmation is received, the server 350 can be operated in such a way as to automatically update the Point of Sale (POS) system which controls what prices are charged at the cash registers. In this way, the price displayed at the shelf can be automatically synchronized with the price charged at the cash register in a robust, reliable, repeatable, and verifiable way.

When the sign 140, 240 is attached to the device 200, 300, the controller 120 may also send a confirmatory message to the hand-held device via the wireless transceiver, e.g., to enable an employee carrying the hand-held device to confirm that the sign has been attached.

Before the sign is attached, the display 130, 210 may continue displaying an old message up to the instance that the sign is attached to the device and the new message takes affect. In this way, the device may continuously display a price switching from the old price to the new price when the presence of the sign is detected.

An additional improvement of the system is that the controller 120 can detect different types of signs 140, 240 that may be attached. The signs 140, 240 can be constructed in such a way as to have different properties to their sign attachment mechanisms 245, such as, for example, different amounts of conductive material on the tab attached to the sign 140, 240, and these property differences can be detected by the controller 120. For example, different amounts of conductive material on the tab changes the inductance by different amounts, which can be detected by the controller to distinguish different types of signs. The controller 120 can then change the message 215 on the display 130, 210 depending on the specific type of sign 140, 240 that is attached. In one implementation, for example, a sign 140, 240 displaying an additional message 247 of a “buy-one-get-one-free” promotion, may be exchanged for a sign 140, 240 displaying a “save $1 when you buy 3” promotion, and the controller 120 can change the message 215 on the display 130, 210 to display the appropriate price given the type of promotion.

For example, as mentioned above, the different sign types may be detected by having different amounts of conductive material on the tab 240 for different types of signs. The different amounts of conductive material change inductance by different amounts, which can be detected by the controller. The controller may detect the change in inductance by a change in mutual inductance between two coils, or a change in self inductance of a single coil. In another implementation, the different sign types can be detected by having different amounts of opaqueness on the tab 240 for the different sign types. The different amounts of opaqueness change light transmission by different amount, which can be detected by the controller. The controller may detect the change in light transmission by inserting the tab between a light emitter and detector.

To further increase the number of detectable sign types, the device may include more than one attachment detector, wherein each attachment detector is configured to detect different regions of the tab 245. When a sign is attached to the device, each region of the tab 245 is aligned with a different one of the attachment detectors of the device. In this example, if each attachment detector individually enables the detection of N different sign types, then a combination of two detectors would enable the detection of N² different sign types, a combination of three detectors would enable the detection of N³ different sign types, and so on.

In an implementation, when a new sign is to be attached to the device, the server may send the device a message including the type of sign to be attached. When the sign is attached, the controller 120 may compare the type of sign detected with the type of sign included in the message. If they do not match, then the controller 120 may alert the employee who attached the sign that the sign is incorrect, e.g., by causing the LED to turn on in a specific pattern an/or an alert message to be displayed on the display. The controller may also send a message to the server and/or hand-held device to alert it of the mismatch. If the two sign types match, then the controller may send a message to the server and/or hand-held device confirming that the correct sign type has been attached to the device. Sending the message to the hand-held device enables, e.g., an employee carrying the hand-held device on the store floor to confirm that the correct sign type has been attached. The hand-held device may also receive this information from the server after the server has received the message from the wireless device.

In another implementation, the LED and/or the display can be used to indicate which type of sign to attach to the device. For example, the controller 120 may cause a double or triple LED blink in rapid succession and/or display a number and/or letter on the display to indicate which type of sign to attach to the device. For example, a single blink can indicate a type 1 sign (e.g., “back to school”) whereas a double blink can indicate a type 2 sign (e.g., “club price). In another example, a double blink can indicate a sign adjustment is required whereas a double blink indicates a promotion. In another example, a single LED blink indicates that the store personnel should press a button at the device to display a special display frame or LED blink pattern that can then encode which type of sign to attach.

1. A wireless device comprising:
a display,
a wireless transceiver;
a light emitting diode (LED);
an interface for attaching an external sign to the wireless device; and
a controller in communication with the display, the wireless transceiver, the LED, and the interface, wherein the controller is configured to detect whether an external sign is attached to the device, and to initiate wireless communication with a remote system via the wireless transceiver based on whether the external sign is attached to the device.

2. The wireless device of claim 1, wherein the controller is configured to change a message on the display based on whether the external sign is attached to the device.

3. The wireless device of claim 1, wherein the controller is configured to control operation of the LED based on whether the external sign is attached to the device.

4. The wireless device of claim 1, wherein the controller is configured to receive a message from the remote server via the wireless transceiver, and to initiate blinking of the LED upon receiving the message.

5. The wireless device of claim 4, wherein the received message includes a new price, and the controller is configured to display the new price on the display after the external sign is attached to the device.

6. The wireless device of claim 5, wherein the controller is configured to display an old price on the display until the external sign is attached to the device.

7. The wireless device of claim 1, wherein the controller is configured to recognize different types of external signs that can be attached to the device, and to take subsequent action based on the type of external sign attached to the device.

8. The wireless device of claim 7, wherein the controller is configured to display a message on the display based on the type of external sign attached to the device.

9. The wireless device of claim 7, wherein the controller is configured to receive a message from the server including a type of sign to be attached to the device, to compare the type of external sign attached to the device with the type of sign in the received message, and to display an alert on the display or cause the LED to blink in a specific pattern when the two types of signs do not match.

10. The wireless device of claim 7, wherein the controller is configured to display a message on the display or cause the LED to blink in a specific pattern to indicate which type of sign to attach to the device.

11. The wireless device of claim 1, wherein the controller is configured to send a message to the server via the wireless transceiver when the external sign is attached to the device.

12. The wireless device of claim 9, wherein the controller is configured to send a message to the server via the wireless transceiver confirming attachment of the correct sign when the two types of signs match.

13. The wireless device of claim 1, wherein the controller is configured to send a message to a hand-held device via the wireless transceiver when the external sign is attached to the device.

14. The wireless device of claim 9, wherein the controller is configured to send a message to a hand-held device via the wireless transceiver confirming attachment of the correct sign when the two types of signs match.

15. A server configured to receive messages from a wireless device confirming attachment, detachment, or replacement of an external attached sign, and to automatically update a point of sale system upon receiving the message to ensure synchronization between a message displayed on the wireless device and cash registers.
